(19) United States
(12) Patent Application Publication
(10) Pub. No.: US 2025/0013871 A1
(43) Pub. Date: Jan. 9, 2025

(54) EXPERIENCE SELECTION IN REINFORCEMENT LEARNING

(71) Applicant: Wells Fargo Bank, N.A., San Francisco, CA (US)

(72) Inventor: Jacob White, Frisco, TX (US)

(21) Appl. No.: 18/895,583

(22) Filed: Sep. 25, 2024

Related U.S. Application Data
(63) Continuation-in-part of application No. 18/295,629, filed on Apr. 4, 2023.

(51) Int. Cl. G06N 3/092; B64G 1/10; B64G 1/24

(52) U.S. Cl. CPC G06N 3/092; B64G 1/1071; B64G 1/242

(57) ABSTRACT

Techniques described herein include selecting experience data for use when training or retraining a model. In one example, this disclosure describes a method that includes generating a plurality of trajectories, each comprising a contiguous sequence of instances of experience data, where each instance of experience data in the contiguous sequence has an error value associated that instance of experience data; determining, for each of the trajectories, a sorted order of the instances of experience data, wherein the sorted order is based on the error value associated with each of the instances of experience data; selecting, based on a distribution function applied to the sorted order of the instances of experience data in at least one of the trajectories, a subset of instances of the experience data; and retraining a reinforcement learning model, using the subset of instances of experience data, to predict an optimal action to take in a state.

### CROSS REFERENCE

This application is a continuation-in-part application of and claims priority to U.S. patent application Ser. No. 18/295,629 filed on Apr. 4, 2023, which is hereby incorporated by reference herein in its entirety.

### TECHNICAL FIELD

This disclosure relates to computing systems, and more specifically, to techniques for training a reinforcement learning model.

### BACKGROUND

Reinforcement learning is one of the major areas of machine learning and can be used to solve a Markov decision process or a partially observable Markov decision process. In reinforcement learning, an agent interacts with an environment, taking actions in an attempt to maximize rewards granted pursuant to a reward structure. Training the agent may involve performing a simulation using the agent and observing both the rewards received by the agent in each state and the effect on the environment resulting from actions taken by the agent. The observed information is then used to train a model to predict, for a given state of the environment, the optimal action for the agent to take in order to maximize future rewards. By iteratively performing simulations, collecting data, and retraining the agent, the skill exhibited by the agent in selecting actions to maximize future rewards tends to improve over time.

### SUMMARY

Techniques described herein include using various attributes of information observed during simulations in new ways, particularly when training a reinforcement learning agent (or a neural network that is used by the agent). For example, while experience-level information is often used to train a reinforcement learning agent, information taken from a different abstraction, as described herein, may also be used to train the reinforcement learning agent, perhaps as a supplement to the experience-level information or as a guide to selecting experiences used for training. In some examples, such information could involve using episode-level data or trajectory-level data when training the reinforcement learning agent, where an “episode” may be considered to be a sequence of experiences in training data ending in a termination state, and where a “trajectory” may be considered a set of contiguous experiences from a single episode or from a single part of a continuous problem. Similarly, it may be beneficial to consider information taken at even higher abstractions when training the agent, such as at the epoch level, where an “epoch” may be considered a collection of one or more episodes.

Techniques described herein include using episode-level or trajectory-level attributes to choose specific training experiences to use during training, which may involve considering the attributes of the episodes or trajectories from which those training experiences are drawn. Such attributes may include the general or specific performance achieved during the episode or trajectory, which may be based on specific objective criteria, such as a reward structure or the score of a video game being simulated. Such attributes may also include timeframes associated with an episode or trajectory, or error associated with an episode or trajectory. Often, attributes may take the form of statistics compiled from collections of experience data and expressed in a numerical form, but such attributes may be in any appropriate form. Similar techniques may be correspondingly applied to epoch-level attributes.

Other higher-level attributes of training data could be used during training, such as state information. In one such example, a computing system training a reinforcement learning model may select training data that is similar to or otherwise associated with a state encountered during training, where identifying a similar state may be based at least in part on attributes of the episode or trajectory from which the training data is drawn. Identifying similar states could performed using an embedding (e.g., embedding the state in the data), which facilitates finding and/or comparing states that have common attributes.

In general, techniques described herein could be used when selecting experience data from an experience replay buffer, affecting the choice of experiences used when training or retraining a model in a reinforcement learning environment. Selected experiences may be drawn from the replay buffer by considering attributes of the episodes, trajectories, and/or epochs from which the experience data is drawn. In some cases, episodes, trajectories, and/or epochs that have particularly desirable attributes, such as a high reward or a short timeframe, could be identified, saved, retained, and used more often for training.

In some examples, certain collections of experience data that make up an episode, trajectory, or epoch having specific (desirable) attributes may be stored together along with information or statistics about those desirable attributes. Further, experience data included in a desirable episode or trajectory may be retained within the replay buffer (or a separate buffer) to ensure availability of that data when training or retraining a model. In such an example, identifying which experience data to purge from a limited-capacity experience replay buffer may be based not only on the age of the experience data, but also attributes of the episode, trajectory, or epoch with which a given instance of experience data is associated.

In other examples, an experience sorting technique may be employed, where experiences within a specific episode or trajectory are sorted by one or more desirable attributes of each experience (e.g., error, temporal difference, reward received, sequence index, or others). Once the experiences are sorted into a list, a model may be retrained by selecting experiences from the sorted list by applying a distribution function to select experiences having certain desirable attributes much more frequently than experiences that lack those desirable attributes. As described herein, it may be appropriate, when selecting experiences from a specific episode or trajectory being used for retraining, to select experiences that tend to have high error values more frequently than experiences that have low error values. Selecting experiences in this manner, as described herein, may lead to reinforcement learning models that are more accurate, are trained more quickly, converge more consistently, and/or are trained with less computational resources.

In some examples, this disclosure describes operations performed by a computing system in accordance with one or more aspects of this disclosure. In one specific example, this disclosure describes a method comprising generating, by a computing system, a plurality of trajectories, each comprising a contiguous sequence of instances of experience data, where each instance of experience data in the contiguous sequence has an error value associated that instance of experience data; determining, by the computing system and for each of the trajectories, a sorted order of the instances of experience data, wherein the sorted order is based on the error value associated with each of the instances of experience data; selecting, by the computing system and based on a distribution function applied to the sorted order of the instances of experience data in at least one of the trajectories, a subset of instances of the experience data; and retraining, by the computing system, a reinforcement learning model, using the subset of instances of experience data, to predict an optimal action to take in a state.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1 is a conceptual diagram illustrating an example system that uses a reinforcement learning model to solve a problem, in accordance with one or more aspects of the present disclosure.

FIG. 2A is a block diagram illustrating an example computing system used for training and/or applying a reinforcement learning model, in accordance with one or more aspects of the present disclosure.

FIG. 2B is a block diagram illustrating an example of how experiences may be selected for training, in accordance with one or more aspects of the present disclosure.

FIG. 2C is a chart illustrating a sample frequency distribution for selecting experiences from a list of experiences that are sorted by an attribute of the experiences, in accordance with one or more aspects of the present disclosure.

FIG. 2D is a chart illustrating another sample frequency distribution for selecting experiences from a list of experiences that are sorted by an attribute of the experiences, in accordance with one or more aspects of the present disclosure.

FIG. 2E is a conceptual diagram illustrating an example of how performance of an agent may evolve during training across multiple epochs, in accordance with one or more aspects of the present disclosure.

FIG. 3 is a flow diagram illustrating operations performed by an example computing system in accordance with one or more aspects of the present disclosure.

FIG. 4 is another flow diagram illustrating operations performed by an example computing system in accordance with one or more aspects of the present disclosure.

### DETAILED DESCRIPTION

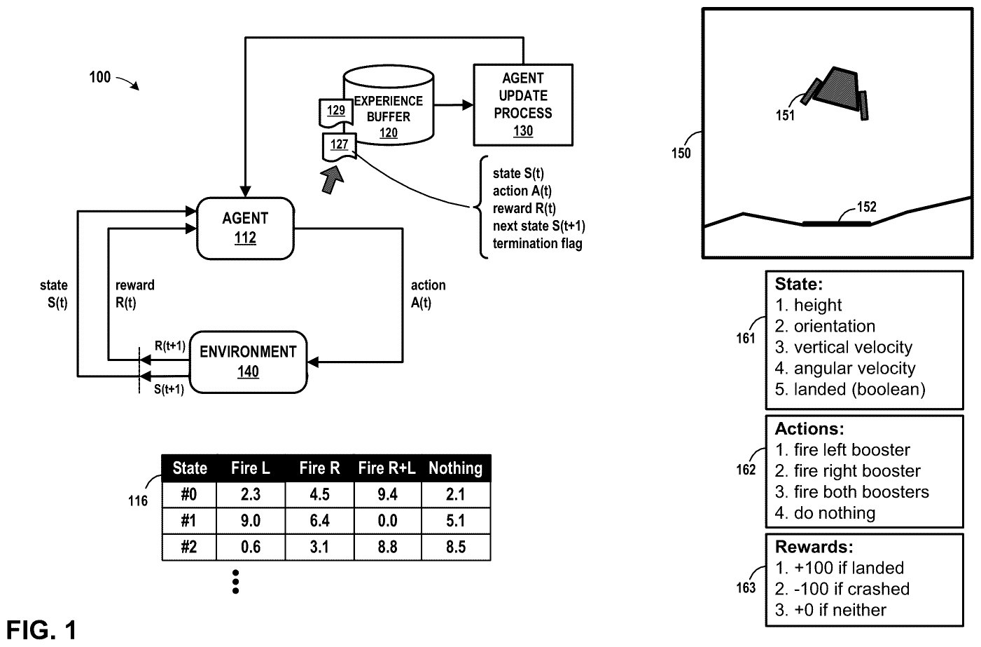

FIG. 1 is a conceptual diagram illustrating an example system that uses a reinforcement learning model to solve a problem, in accordance with one or more aspects of the present disclosure. Aspects of the present disclosure can be described in various contexts, but in this disclosure, such aspects are primarily described in the context of solving a robotic control problem using reinforcement learning. The techniques described herein, however, may apply to any reinforcement learning scenario.

One well-known robotic control problem used in reinforcement learning involves controlling an object (e.g., a spaceship or rocket) that is landing on the surface of a planet. This robotic control problem is sometimes known as the “lunar lander” problem. A representation of the lunar lander problem is illustrated in FIG. 1, where object 151 is shown in space above landing pad 152, where landing pad 152 is on the surface of a planet.

The lunar lander problem could be the basis for a video game, where the user's objective in the video game is to choose actions to successfully land object 151 on landing pad 152 without crashing. Such a video game could also be operated by an artificially intelligent agent, rather than a human user, and reinforcement learning techniques could be used to improve the skill of the artificially intelligent agent (hereinafter “agent 112”) in playing the video game. As described herein, agent 112 is configured to interact with simulator 150, which represents the lunar lander video game. Simulator 150 may therefore be controlled by agent 112, effectively enabling agent 112 to play the video game just as would a human agent.

Reinforcement learning system 100 of FIG. 1 is a state diagram which can be used to describe and illustrate a Markov decision process forming the basis for a reinforcement learning model. In reinforcement learning system 100 of FIG. 1, agent 112 receives as input, at time “t,” a state S(t) (e.g., a state of the lunar lander video game) and a reward R (t) associated with that state of environment 140 (e.g., the position and other attributes of object 151 within simulator 150). In response to receiving information about the current state, agent 112 predicts the optimal action A (t) to be taken at time “t,” where the “optimal action” could be defined, for at least some examples described in this disclosure, as the action that is most likely to maximize future video game points awarded by simulator 150. In general, scoring game points in a lunar lander video game would generally correspond to actions that successfully land object 151 on landing pad 152. Accordingly, at each time “t,” agent 112 identifies the predicted optimal action, and performs that action by interacting with simulator 150.

Each action taken by agent 112 has an effect on environment 140 of simulator 150 and causes environment 140 to be transitioned to a new state S(t+1) at time “t+1.” That new state has associated with it a new reward (i.e., R (t+1)). Agent 112 in FIG. 1 then repeats the process for the new state at time t+1. At each successive time “t,” agent 112 determines a predicted “optimal action” for each state, performs the action by interacting with simulator 150, and thereby affects environment 140 of simulator 150 in some way. The process continues until a termination condition is reached, such as object 151 landing successfully or crashing. Other conditions may also cause the process or episode to terminate, but for the purposes of describing the simplified example of FIG. 1, each episode ends with either a successful landing or a crash.

State definition 161, as shown in FIG. 1, outlines one possible way to define the state of environment 140 within simulator 150. In the example of FIG. 1, state definition 161 includes four attributes, including the height of object 151 above landing pad 152, the orientation of object 151 relative to landing pad 152, the vertical and angular velocity of object 151, and a flag or Boolean value indicating whether object 151 is resting on landing pad 152.

Action space 162, as also shown in FIG. 1, outlines one possible collection of actions available to agent 112. In the example of FIG. 1, action space 162 includes four actions, meaning that at any given time, the user or agent 112 can select from four actions for controlling or affecting environment 140 of simulator 150. Those four actions are firing the left booster, firing the right booster, firing both boosters, or doing nothing (i.e., allowing only the force of gravity to affect the motion of object 151).

Solving the lunar lander problem with reinforcement learning involves use of a reward structure 163, providing a criteria that agent 112 can use to choose actions that maximize rewards. In other words, since the optimal action for a given situation in simulator 150 or state of environment 140 might not be known (or would be difficult to accurately determine), there is not likely to be readily available training data that would be effective in training a supervised learning model to predict an optimal action for controlling simulator 150 in a given state. However, reinforcement learning techniques can be used to train agent 112 to choose actions that maximize rewards (or minimize penalties) that are defined according to reward structure 163. Preferably, rewards in the reward structure are defined in a way that causes agent 112 to choose an action that is optimal for a given state in the sense that it advances agent 112 toward solving the problem sought to be solved. Where the problem to be solved involves a video game, the reward structure used for reinforcement learning can mirror or mimic the rewards (i.e., game points) granted by the game itself.

For example, reward structure 163 outlines one possible structure for granting rewards to agent 112 when interacting with simulator 150. Agent 112 may take any of the four actions in action space 162, and in some cases, agent 112 may receive a reward in response to the action. In the simplified reward structure 163 of FIG. 1, if an action taken by agent 112 results in object 151 landing successfully on landing pad 152, agent 112 receives a reward of 100 points. If an action taken by agent 112 results in object 151 crashing, agent 112 receives a negative reward (i.e., agent 112 loses 100 points). If object 151 neither lands successfully nor crashes, agent 112 receives no reward. In some examples, a negative reward (i.e., a penalty) may apply in some cases. For example, some small number of points (e.g., five points) might be deducted each time a booster is fired.

In reinforcement learning, agent 112 is trained to choose the optimal action in each state, as defined by the expected future rewards resulting from the selected action. The optimal action is defined by an optimal action-value function (sometimes known as a “Q function”). Techniques described herein may be most applicable in the Q-learning context or the deep Q-learning context (in which a neural network is trained to predict an optimal action for agent 112 to take).

In some cases, and for purposes of providing a simplified explanation, an optimal action-value function can be conceptually represented by a Q table, which lists expected future reward values for each state/action pair. Q table 116, shown in FIG. 1, is an example representation of the Q values generated by a machine learning model (or neural network) for each action in each state. Each Q value within Q table 116 represents the maximum expected future reward for each action that can be taken in a given state. For each possible state (e.g., states #0 through #N, where N could be any number), available actions (fire some combination of boosters, or do nothing) have an associated value or expected future return. When presented with a state, agent 112 uses Q table 116 to choose an optimal action for a given state, typically by identifying the action having the highest return (e.g., for state 1, agent 112 would typically choose the “fire left booster” action, since it has the highest Q value).

Agent 112 might be initially configured to choose random actions when presented with a given state of environment 140 (e.g., Q table 116 may be initially seeded with random numbers, or all zeros). After each random action, the effect of the action on environment 140 is observed and information about that effect can be saved for later use in refining the values of Q table 116. Specifically, for each action taken by agent 112 when presented with a given state, the effect of that action on environment 140 and the reward that results can be observed and assembled into experience data 127. Experience data 127 may therefore be a data structure that includes a set of information describing an action taken by agent 112 and the effect that the action has on environment 140. Typically, experience data 127 includes the current state S(t), the action A (t) taken by agent 112, the reward R (t) received by agent 112 in the current state, the next state S(t+1), and a termination flag. Since each action taken by agent 112 affects environment 140 and/or changes the state of simulator 150, each action moves environment 140 or simulator 150 into a new, different state S(t+1). In some cases, the action results in a termination condition, meaning that the objective of the agent has been completed. In the context FIG. 1, a termination condition involves either a successful landing or crash of object 151 within simulator 150. The termination flag thus may identify experiences that result in a termination condition.

In some of the examples described herein, once a termination condition is reached, the set of experience data 127 corresponds to one completed episode. In reinforcement learning problems where there is a termination condition (e.g., successful landing or crash of object 151), it may therefore be appropriate to group a series of experience data 127 as an episode. Techniques described herein also apply to other types of reinforcement learning problems, however, such as continuous reinforcement scenarios that might be defined as not having a specific termination condition. One such reinforcement learning problem involves predicting movements of financial markets, where a specific stock, security, or other financial instrument is repriced frequently (e.g., continuously during market hours) over an indefinite time period. Some financial instruments can trade (and be repriced) for decades without a specific defined termination condition. In such examples, it may be appropriate to group a series of experience data 227 as a “trajectory,” where a trajectory may be defined as a set of contiguous experiences drawn from a single episode or from a single part of a continuous problem. Accordingly, a trajectory can describe a sequence of experiences that apply to both episodic tasks as well as continuous tasks, even if in the case of episodic tasks the trajectory starts at the beginning of an episode and ends with the terminal state. Further, algorithms and techniques described herein may be designed to accommodate both episodic tasks and continuous tasks by defining the problem and sequences of experiences in terms of a trajectory.

As described above, each instance of experience data 127 is stored in experience buffer 120. In addition, and in connection with the larger abstraction of an episode (or trajectory), episode data 129 is also stored, where the episode data 129 includes additional information about the episode (or trajectory), beyond simply the sequence of experience data 127. Episode data 129 may include, for example, information about whether the episode was generally successful (e.g., the object 151 was landed successfully or crashed), the reward or score achieved by the actions taken by agent module 212 in the episode (e.g., a video game score), the total amount error associated with actions taken and predicted rewards for those actions, the timeframe information such as the number of steps or length of time taken to complete the episode, or other statistical or other information about the episode. As described herein, episode data 129 may be used in some examples when selecting data during training or retraining agent 112. By using episode data 129 to select experience data 127, for example, it may be possible to more effectively train agent 112 to predict which action will optimize future rewards when interacting with simulator 150.

In FIG. 1, and in accordance with one or more aspects of the present disclosure, agent update process 130 may select data to use when training or retraining agent 112. For instance, in an example that can be described within the context of FIG. 1, agent update process 130 selects a subset of the experience data 127 stored in experience buffer 120. Agent update process 130 selects the subset of experience data 127 for the purpose of training or retraining agent 112. When selecting the subset of experience data 127, agent update process 130 selects at least some of the experience data 127 in the subset from episodes having particular desired attributes (e.g., episodes in which a high score was achieved, episodes having a small (or large) number of steps, episodes having a short (or long) timeframe, or episodes in which a high total error was observed). To determine which episodes (and experiences) have the desired attributes, agent update process 130 uses episode data 129. In some examples, all of the experience data 127 are drawn from episodes with the desired attributes. In other examples, only a fraction of the experience data 127 are drawn from such episodes, and the remaining instances of experience data 127 may be drawn from experience buffer 120 uniformly, or at random (e.g., pursuant to a conventional experience replay approach).

Agent update process 130 may train or retrain agent 112 using the selected subset of experience data. For instance, continuing with the example being described within the context of FIG. 1, agent update process 130 evaluates the selected subset of experience data 127 and determines the rewards that result from actions taken in the states represented by the subset of experience data 127. Agent update process 130 uses the determined reward and action information to train a machine learning model (e.g., a neural network) to predict an expected reward for each of the actions that could be taken for a given state. Agent update process 130 updates agent 112 with the newly trained machine learning model (e.g., replacing the prior model or neural network used by agent 112). As a result of such training or retraining, the model typically becomes more skilled at generating an expected optimal value or expected return (sometimes known as a “Q value”) for various actions in given states.

After agent 112 is updated, agent 112 may perform another simulation by interacting with simulator 150. For instance, agent 112 interacts with simulator 150, starting a new simulation. At each time step, agent 112 uses the newly trained model (or newly updated Q table 116) to predict, based on the state information associated with environment 140, an optimal action expected to result in maximum future rewards. In other words, when agent 112 interacts with simulator 150 during a simulation, agent 112 predicts, for each state and using Q table 116, the expected return value for each of the actions that could be taken in a given state. Typically, agent 112 will choose the action having the highest expected return, and then perform the action by interacting with simulator 150.

Although in most instances agent 112 will choose the action having the highest expected return, agent 112 may also occasionally choose a random action, to ensure that at least some experience data 127 is collected that enables the model to evolve and avoid local optima. Specifically, while agent 112 may apply an epsilon-greedy policy so that the action with the highest expected return is chosen often, agent 112 may nevertheless balance exploration and exploitation by occasionally choosing a random action rather than the action having the highest expected return.

After agent 112 performs each action, the effect on environment 140 is observed and saved within experience buffer 120 as a new instance of experience data 127, thereby eventually resulting a new collection of stored experience data 127. The process may continue, with agent 112 making predictions, performing actions, and the resulting new experience data 127 being stored within experience buffer 120. Once a termination condition is reached, agent 112 stores the collection of experience data 127 associated with the completed episode within experience buffer 120. Along with the collection of experience data 127, agent 112 stores episode data 129, which may include various statistics about the episodes corresponding to the simulations performed by agent 112.

After a sufficient number of new episodes are collected through simulation (e.g., sufficient to constitute an epoch of training data), agent update process 130 may again retrain the model that agent 112 uses to make predictions. For example, agent update process 130 accesses a new subset of experience data 127 from experience buffer 120. When selecting the subset of experience data 127, agent update process 130 uses episode data 129 to select specific types of experiences (e.g., agent update process 130 may tend to select experience data 127 associated with high reward episodes or select experiences having a state similar to one encountered during training). Agent update process 130 again updates the machine learning model or neural network used by agent 112 with the newly trained model. Thereafter, agent 112 uses the new model when choosing actions to take during later simulations using simulator 150.

Over time, by collecting new experience data 127 and retraining agent 112 with the new experience data 127 (selected based on episode data 129), the skill with which agent 112 predicts actions will improve. Eventually, agent 112 may arrive at an action selection policy that tends to optimize the rewards received pursuant to reward structure 163, and thereby optimize selection of actions taken in a given state that increase the odds of successfully landing object 151 on landing pad 152 within simulator 150.

In a typical experience replay approach in reinforcement learning, experience buffer 120 has a finite size, so only the most recent experience data 127 is kept within experience buffer 120. When experience buffer 120 reaches its capacity, typically the oldest experience data 127 is removed from experience buffer 120 in order to make room for newer experience data 127. However, in accordance with techniques described herein, instances of experience data 127 that are from episodes having particular attributes (e.g., high reward episodes or episodes having specific step-count, timeframe, or error attributes) may be retained within experience buffer 120 to ensure they can continue to be used for retraining. Accordingly, in at least some examples, purging experience data 127 from a limited capacity 120 may involve considerations other than the age of the experience data 127. Specifically, such considerations may be based on episode data 129.

In the example described above in connection with FIG. 1, agent update process 130 selects a subset of the experience data 127 stored in experience buffer 120, in some cases by selecting experience data 127 from episodes having particular desired attributes. Agent update process 130 may use episode data 129 to identify those episodes having the desired attributes.

In a different example, however, agent update process 130 may assemble experience data 127 for each episode into lists of experiences, sorted by an attribute of the experiences, which could be the reward, index, or error associated with the experience. The error associated with the experience may be considered to be the difference between the reward observed when taking the action in the experience and the expected reward.

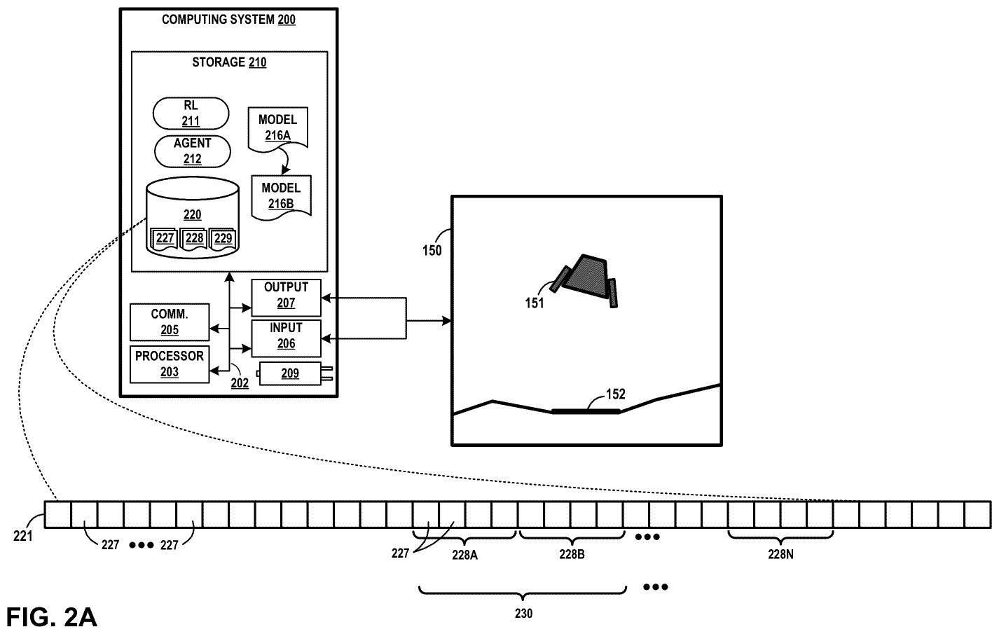

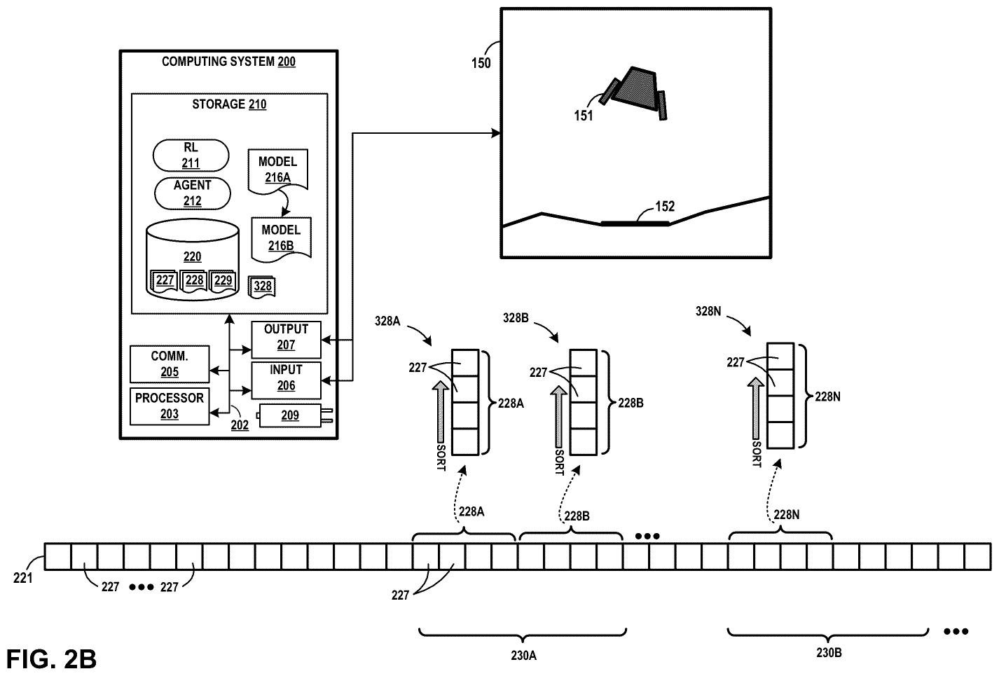

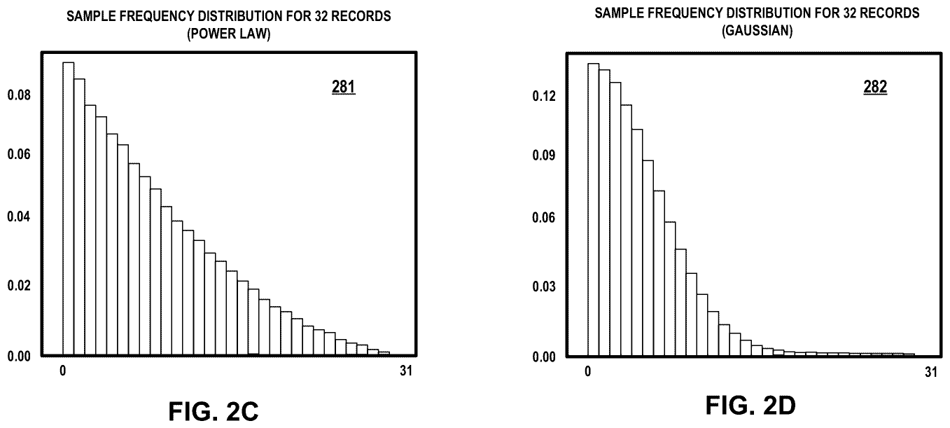

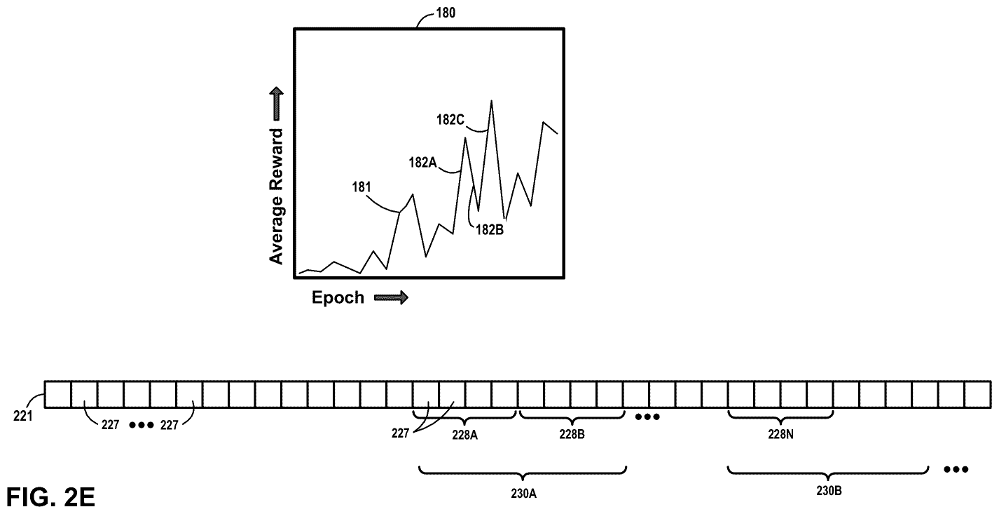

In an example in which the lists of experiences are sorted by error, and as further described in connection with FIGS. 2B, 2C, and 2D, agent update process 130 selects, for retraining, a subset of the experience data 127 by applying a sampling distribution function that causes the agent update process 130 to more frequency sample, for a given episode, those experiences 127 having high error. The effect is that agent update process 130 trains or retrains agent 112 using experience data 127 that tents to have a high amount of error than average. As in the prior example, after agent 112 is updated in this example, agent 112 performs another simulation by interacting with simulator 150, and new experience data 127 is collected. For each experience, the error associated with the experience is updated, and the new experience data 127 is stored in lists of experiences sorted by the observed error. Agent update process 130 again applies a sampling distribution function to the sorted lists that tends to select, for retraining, experience data 127 having high error. Over time, agent 112 arrives at an action selection policy that tends to optimize the rewards received pursuant to reward structure 163, and thereby optimize selection of actions taken in a given state. If training is effective, the selected actions increase the odds of successfully landing object 151 on landing pad 152 within simulator 150.

Techniques described herein may provide certain technical advantages. For example, by using episode-level and/or epoch-level attributes to select experience data for training agent 112, agent update process 130 may be more effective at improving the predictive skill of agent 112. Specifically, agent update process 130 may be able to more quickly and efficiently improve the skill of agent 112 in predicting an optimal action in a reinforcement learning problem. Further, by selecting experience data 127 to use for retraining based on episode data 129 (or epoch data), the variance exhibited in the average rewards for each training epoch may be reduced, enabling a more accurate assessment of the rate at which the performance of agent 112 is improving during training. Still further, by selecting experience data 127 based on episode data 129 only a fraction of the time (randomly or uniformly or otherwise selecting experience data 127 at other times), agent update process 130 may be trained more effectively, with less variance in average reward or other indicia of model skill.

Still further, by assembling experience data 127 for each episode into sorted lists of experiences, significant computational advantages may be achieved. For example, while it may be possible to create a single list of experience data 127 for all episodes, maintaining such a large list in sorted order is likely to consume significant computing resources, and may result in slower training or retraining, and possibly less effective training and prediction accuracy. Maintaining episode or trajectory-level lists make maintaining the sort order less computationally intensive, because a change in the sorted attribute for one experience may require resorting only a small list, rather than a significantly larger list. Accordingly, maintaining multiple smaller sorted lists, each of which may be associated with a single episode or trajectory, may lead to less consumption of computational resources. Sorting or other maintenance of the lists may be performed faster and may also result in higher prediction accuracy for the trained agent 112.

FIG. 2A is a block diagram illustrating an example computing system for training and/or applying a reinforcement learning model, in accordance with one or more aspects of the present disclosure. FIG. 2A includes computing system 200, illustrated as a block diagram with specific components and functional modules. In examples described in connection with FIG. 2A, computing system 200 may correspond to, or may be considered an example or alternative implementation of reinforcement learning system 100 of FIG. 1.

For ease of illustration, computing system 200 is depicted in FIG. 2A as a single computing system. However, in other examples, computing system 200 may comprise multiple devices or systems, such as systems distributed across a data center or multiple data centers. For example, separate computing systems may implement functionality performed by each of reinforcement learning module 211 or agent module 212, described below. A separate system could also be used to perform training operations. Alternatively, or in addition, computing system 200 (or various modules illustrated in FIG. 2A as being included within computing system 200) may be implemented through distributed virtualized compute instances (e.g., virtual machines, containers) of a data center, cloud computing system, server farm, and/or server cluster, or in any other appropriate way.

Also, although both FIG. 1 and FIG. 2A illustrate various systems separately, some of such systems may be combined or included within functionality performed by computing system 200. For example, computing systems included within one or more computing systems within reinforcement learning system 100 of FIG. 1 may be integrated into computing system 200. Alternatively, or in addition, computing systems described as part of simulator 150 may be integrated into computing system 200.

In FIG. 2A, computing system 200 is illustrated as including underlying physical hardware that includes power source 209, one or more processors 203, one or more communication units 205, one or more input devices 206, one or more output devices 207, and one or more storage devices 210. Storage devices 210 may include reinforcement learning module 211 and agent module 212. These modules may apply and/or generate one or more models 216, such as by using reinforcement learning techniques. One or more of models 216 may be neural networks to be used in deep Q-learning.

Storage devices 210 may also include data store 220. Data store 220 may be or may include buffer 221, which can be used to store various instances of experience data 227 and other information. In some examples, buffer 221 and/or data store 220 may be used to store data about experiences or state transitions performed by agent module 212 when interacting with simulator 150, similar to the description provided in connection with FIG. 1. Buffer 221 may correspond to what is sometimes known as an experience replay buffer, and may store sequences of experience data 227, some of which are selected for use in retraining one or more models 216. Each sequence of experience data 227 may be part of a simulation episode 228 (e.g., episodes 228A, 228B, through 228N). One or more episodes 228 may form a training epoch 230. Accordingly, buffer 221 may include multiple epochs 230, each comprising one or more episodes 228, with each episode 228 comprising one or more instances of experience data 227.

Power source 209 of computing system 200 may provide power to one or more components of computing system 200. One or more processors 203 of computing system 200 may implement functionality and/or execute instructions associated with computing system 200 or associated with one or more modules illustrated herein and/or described below. One or more processors 203 may be, may be part of, and/or may include processing circuitry that performs operations in accordance with one or more aspects of the present disclosure. One or more communication units 205 of computing system 200 may communicate with devices external to computing system 200 by transmitting and/or receiving data, and may operate, in some respects, as both an input device and an output device. In some or all cases, communication unit 345 may communicate with other devices or computing systems over a network.

One or more input devices 206 may represent any input devices of computing system 200 not otherwise separately described herein, and one or more output devices 207 may represent any output devices of computing system 200 not otherwise separately described herein. Input devices 206 and/or output devices 207 are primarily described as supporting interactions with simulator 150 by computing system 200. In general, however, input devices 206 and/or output devices 207 may generate, receive, and/or process output from any type of device capable of outputting information to a human or machine. For example, one or more input devices 206 may generate, receive, and/or process input in the form of electrical, physical, audio, image, and/or visual input (e.g., peripheral device, keyboard, microphone, camera). Correspondingly, one or more output devices 207 may generate, receive, and/or process output in the form of electrical and/or physical output (e.g., peripheral device, actuator). Although input devices 206 and output devices 207 are described herein as the primary interface with simulator 150, in other examples, computing system 200 may interact with simulator 150 over a network using communication unit 205.

One or more of the devices, modules, storage areas, or other components of computing system 200 may be interconnected to enable inter-component communications (physically, communicatively, and/or operatively). In some examples, such connectivity may be provided by through communication channels, which may include a system bus (e.g., communication channel 202), a network connection, an inter-process communication data structure, or any other method for communicating data.

One or more storage devices 210 within computing system 200 may store information for processing during operation of computing system 200. Storage devices 210 may store program instructions and/or data associated with one or more of the modules described in accordance with one or more aspects of this disclosure. One or more processors 203 and one or more storage devices 210 may provide an operating environment or platform for such modules, which may be implemented as software, but may in some examples include any combination of hardware, firmware, and software. One or more processors 203 may execute instructions and one or more storage devices 210 may store instructions and/or data of one or more modules. The combination of processors 203 and storage devices 210 may retrieve, store, and/or execute the instructions and/or data of one or more applications, modules, or software. Processors 203 and/or storage devices 210 may also be operably coupled to one or more other software and/or hardware components, including, but not limited to, one or more of the components of computing system 200 and/or one or more devices or systems illustrated or described as being connected to computing system 200.

Reinforcement learning module 211 may perform functions relating to training one or more models 216 and managing various data used by computing system 200 (e.g., experience data 227, episodes 228, episode data 229) when training or retraining models 216.

Reinforcement learning module 211 may also orchestrate interactions with simulator 150, causing agent module 212 to initiate a simulation or conduct other operations with respect to simulator 150. Reinforcement learning module 211 may perform at least some of the operations performed by agent update process 130 described in connection with FIG. 1.

Agent module 212 may perform functions relating to interacting with simulator 150, such as selecting and performing actions pursuant to a simulation on simulator 150. In order to select actions to take with respect to simulator 150, agent module 212 may apply one or more models 216. Agent module 212 may perform at least some of the operations performed by agent 112 described in connection with FIG. 1.

In FIG. 2A, and in accordance with one or more aspects of the present disclosure, computing system 200 may start a simulation. For instance, in an example that can be described in the context of FIG. 2A, input device 206 of computing system 200 detects input and outputs information about the input to reinforcement learning module 211 of computing system 200. Reinforcement learning module 211 determines that the input corresponds to a command (e.g., from an administrator) to perform a simulation and collect data about the simulation. Reinforcement learning module 211 interacts with agent module 212 and configures agent module 212 to operate simulator 150 (e.g., configuring input device 206 and output device 207 to interact with simulator 150).

Computing system 200 may take an initial action after starting simulator 150. For instance, continuing with the example being described in the context of FIG. 2A, agent module 212 of computing system 200 starts simulator 150 and chooses an initial action to perform, based on the initial or starting state of the process represented by simulator 150 (e.g., the lunar landing game). Agent module 212 performs the chosen action and observes the effect on the environment of simulator 150. For example, agent module 212 determines whether any reward was obtained (e.g., pursuant to a reward structure 163), or whether a termination state was reached terminating the episode (e.g., a successful landing or a crash). Agent module 212 determines or receives from simulator 150 the new state after the initial action. Agent module 212 stores information about the experience of taking the initial action in data store 220 as experience data 227.

In the example being described, that experience data 227 may be represented by a data tuple identifying the first or initial state of simulator 150, the action taken, the next or second state, the reward (if any) received for the action, and an indication of whether the second state is a termination state. In such a tuple, both the identified initial (first) state and the next (second) state would typically include information sufficient to identify each of the values in state definition 161 (see FIG. 1). The action taken would correspond to one of the actions specified in available actions 162. Any rewards or penalties resulting from the initial action would be based on reward structure 163. The tuple may also indicate whether object 151 successfully landed or crashed, which would correspond to a termination state.

Computing system 200 may perform additional actions on simulator 150. For instance, still referring to FIG. 2A, agent module 212 chooses a new action to perform based on the second state (which resulted from the initial action taken by agent module 212). Agent module 212 performs the new action and observes the effect of the chosen action. Agent module 212 stores in data store 220 an additional set of experience data 227, providing information about the current state, the action taken, the next (i.e., third) state, any reward received, and an indication of whether a termination state has been reached. Agent module 212 continues this process, performing a series of actions on simulator 150, advancing to a next state, and observing the effect of the chosen action on simulator 150. Each time, agent module 212 stores in data store 220 a set of experience data 227. In general, each instance of experience data 227 would include a tuple of data having the form described above (state information, action taken, reward received, next state, termination flag).

Computing system 200 may choose actions based on a policy. For instance, in the example being described above, agent module 212 chooses an action to take for each new state. To choose the action, agent module 212 applies model 216A, which is configured to predict the action that will tend to lead to the highest future reward in simulator 150. In each new state, agent module 212 uses model 216A to determine the appropriate or optimal action to take. Conceptually, model 216A may be a table of values, with predicted future rewards for each action that could be taken in each state, similar to Q table 116 in FIG. 1B. In such an example, agent module 212 looks up the current state in Q table 116 to determine the predicted future reward values corresponding to each action that can be taken by agent module 212 in the current state. Although the Q value function is represented in FIG. 1B as a table, the Q value function may take a more complicated form, such as a mathematical function or model that is generated by or represented by a neural network, as in deep Q-learning.

Computing system 200 may tend to perform the action with the highest expected future reward. For instance, again with reference to the example being described in connection with FIG. 2A, agent module 212 uses, for example, Q table 116 to identify the action having the highest Q value (i.e., where the Q value represents the expected future reward for a given action). In most cases, agent module 212 will perform that chosen action on simulator 150, particularly when agent module 212 is operating under an epsilon-greedy policy. At times, however, agent module 212 might not perform the action with the highest Q value. Instead, agent module 212 may choose an action randomly (particularly early in training), so as to balance exploration with policy exploitation.

Computing system 200 may store data about the collection of state/action transitions taken during an episode. For instance, still referring to the example being described, agent module 212 continues performing state/action transitions by taking actions, observing the effect of those actions, receiving rewards, arriving at a new state, and storing experience data 227. Typically, after enough state/action transitions are completed by agent module 212, agent module 212 will eventually either successfully land simulator 150 or cause simulator 150 to crash (i.e., reach a termination condition). Once a termination condition is reached, the simulation episode being run by agent module 212 is considered a complete (an episode may be considered to be from the start of the simulation to the end of the simulation). Upon completing the episode, agent module 212 outputs information to reinforcement learning module 211. Reinforcement learning module 211 determines, based on the information, that a simulation episode has completed. Reinforcement learning module 211 compiles, into a sequence of experience data 227, the series of state/action transitions that led to the termination state. Reinforcement learning module 211 stores the sequence of experience data 227 within buffer 221 of data store 220 as episode 228A.

Computing system 200 may also store additional data about episode 228A. For instance, reinforcement learning module 211 may, after completing episode 228A, determine various episode data 229 associated with episode 228A. Episode data 229 may include additional data about the episode which is sometimes ignored or underutilized when developing reinforcement learning models. As described herein, various episode data 229 may be effectively used in various ways to improve reinforcement models 216, including when selecting experiences used to retrain models 216. In some examples, episode data 229 may include whether the episode 228A was generally successful (e.g., the object 151 was landed successfully or crashed), the reward or score achieved by the actions taken by agent module 212 in the episode, the total amount error associated with actions taken and predicted rewards for those actions, or timeframe information such as the number of steps or length of time taken to complete the episode. Reinforcement learning module 211 stores episode data 229 for episode 228A within 220. Computing system 200 may generate and store information about additional experiences 227 and episodes 228. For instance, again referring to the example, agent module 212 continues the process, performing additional simulations, generating additional experience data 227, compiling the experience data 227 into episodes 228, and generating episode data 229 for each such episode 228. After agent module 212 completes each episode, reinforcement learning module 211 collects the series of experience data 227 for that episode and stores the set of experience data 227 in buffer 221 as an episode 228 (e.g., one of episodes 228A through 228N). Agent module 212 also stores episode data 229 associated with each episode within data store 220 or within buffer 221.

Computing system 200 may determine that sufficient experience data 227 has been collected to retrain model 216A. For instance, again with reference to an example that can be described in the context of FIG. 2A, reinforcement learning module 211 monitors simulation activities performed by agent module 212. Eventually, reinforcement learning module 211 determines that enough data has been collected in data store 220 and buffer 221 to form a training epoch 230. In some examples, epoch 230 may include one or more complete episodes, each representing a series of experience data 227 for a given episode 228, along with episode data 229 about that episode.

Computing system 200 may select instances of experience data 227 from epoch 230. For instance, still referring to FIG. 2A, reinforcement learning module 211 selects a subset of the experience data 227 for epoch 230 that is stored within buffer 221. Conventionally, pursuant to experience replay techniques, buffer 221 stores a series of the most recent experience data 227 representing state/action transitions performed by agent module 212 on simulator 150. Also pursuant to conventional experience replay techniques, reinforcement learning module 211 selects instances of experience data 227 for use in retraining model 216A uniformly (i.e., randomly).

In accordance with techniques disclosed herein, however, reinforcement learning module 211 selects instances of experience data 227 based, at least in part, on episode data 229. For example, reinforcement learning module 211 may tend to select, for retraining purposes, instances of experience data 227 that occur during episodes 228 where object 151 was successfully landed on landing pad 152. Alternatively, or in addition, reinforcement learning module 211 may tend to select instances of experience data 227 from episodes that had a high total reward or score awarded by simulator 150. Alternatively, or in addition, reinforcement learning module 211 may tend to select instances of experience data 227 from episodes that had certain temporal attributes (e.g., object 151 was landed quickly). Alternatively, or in addition, reinforcement learning module 211 may tend to select instances of experience data 227 from episodes that had a high (or low) amount of total error associated with the actions taken and predicted rewards. Alternatively, or in addition, reinforcement learning module 211 may tend to select instances of experience data 227 from episodes having one or more states that are similar to a state encountered during training. Computing system 200 may update model 216 using the selected instances of experience data 227. For instance, again with reference to FIG. 2A, reinforcement learning module 211 uses the selected experience data 227 (which may be selected based on episode data 229) to train a model to predict an expected reward as a function of the state of simulator 150. The training results in new values for the optimal action-value function (e.g., represented by Q table 116). Reinforcement learning module 211 updates a neural network (or Q table 116) based on these new values, thereby resulting in model 216B. Thereafter, when reinforcement learning module 211 directs agent module 212 to perform a simulation, agent module 212 uses the updated model 216B to select actions during the simulation.

By retraining model 216A using experience data 227 in a way that tends to select certain experiences 227 drawn from specific episodes 228 or drawn from episodes 228 having certain positive attributes (e.g., successful episodes), reinforcement learning module 211 may be able to more effectively refine model 216. In some examples, reinforcement learning module 211 may select, for training purposes, only experience data 227 associated with episodes 228 that have a specific or desirable attribute (e.g., high/low reward score, short/long timeframe). In other examples, however, reinforcement learning module 211 may only occasionally randomly select (e.g., 20% of the time) experience data 227 from episodes 228 having a specific attribute. Reinforcement learning module 211 may, for the other 80% of the time, select experience data 227 without considering episode data 229. In such an example, reinforcement learning module 211 may randomly select experience data 227 from buffer 221 for that 80% of the time. In still other examples, reinforcement learning module 211 may select experiences 227 that tend to have certain attributes (e.g., a high amount of error), as further described in connection with FIG. 2B.

The process of running simulations to collecting data for epochs 230 (i.e., experience data 227 and episode data 229) followed by retraining model 216 using each of the epochs 230 may be performed repeatedly. Over time, such repeated retraining may improve and/or refine the optimal action-value function (or model) used by agent module 212 to skillfully predict actions that will result in the highest future reward for a given state. As agent module 212 more skillfully selects actions when interacting with simulator 150, agent module 212 will become more skilled at landing object 151 on landing pad 152 without crashing.

FIG. 2B is a block diagram illustrating another example of how experiences may be selected for training, in accordance with one or more aspects of the present disclosure. FIG. 2B is similar to FIG. 2A, and includes many of the same elements of FIG. 2A, including computing system 200. In many respects, computing system 200 may operate in a manner similar to that described in connection with FIG. 2A. However, in the example of FIG. 2B, computing system may apply a sorting technique in which experiences 227 for each episode are ordered in a list based on one or more attributes of each experience.

For example, in FIG. 2B, and as in the example described in connection with FIG. 2A, agent module 212 performs state/action transitions by taking actions based on an existing model 216A, observing the effect of those actions, receiving rewards, arriving at a new state, and storing experience data 227. In FIG. 2B, agent module 212 stores, for each instance of experience data 227, information about the action or the effect of the action taken. Such attributes may involve the order or index of the action, the error observed, the reward received, or another attribute.

In specific one example, agent module 212 stores the error observed when taking the action associated with the experience, where the error may be considered the difference between the observed reward and the expected reward (i.e., as predicted by the current version of model 216). Agent module 212 stores each instance of experience data 227 for a given episode 228 in a sorted list 328, where the lists 328 are implemented through an appropriate data structure that facilitates retrieval of experience data 227 sorted by the magnitude of the error associated with each experience 227. Accordingly, in FIG. 2B, sorted list 328A may be a data structure corresponding to a list of the experiences 227 in episode 228A sorted by the observed error for each experience 227. Similarly, sorted list 328B may be a data structure corresponding to a list of the experiences 227 in episode 228B sorted by the observed error for the experiences in episode 228B. And in general, sorted list 328N may be a data structure corresponding to a list of the experiences 227 in episode 228N sorted by observed error.

Computing system 200 may select, using lists 328, instances of experience data 227 for training. For instance, with reference to FIG. 2B, reinforcement learning module 211 randomly selects an episode in a given epoch 230 as a source of training data. In one example, reinforcement learning module 211 selects episode 228A from epoch 230A. Reinforcement learning module 211 then selects instances of experience data 227 from sorted list 328A associated with the selected episode 228A. When selecting experiences, reinforcement learning module 211 selects experiences within sorted list 328A that tend to have high error. Since the experiences in list 328A are sorted by error, reinforcement learning module 211 will often select experiences at or near the top of the list (i.e., assuming list 328A is sorted in descending order of error magnitude). In some examples, reinforcement learning module 211 might select, each time, the highest error experience data 227. However, this may result in a sequence of training data that is too concentrated with high error experiences, potentially leading to less-than-optimal training effects. It may be more effective for reinforcement learning module 211 to apply a selection algorithm that will select high-error experience data 227 from sorted list 328A much of the time while also balancing those high-error selections with experiences 227 having lower error (e.g., experiences further down in sorted list 328A). This type of balanced approach is further described in connection with FIG. 2C and FIG. 2D.

Computing system 200 may update model 216A using the selected instances of experience data 227. For instance, again with reference to FIG. 2B, reinforcement learning module 211 uses the experience data 227 chosen from list 328A to retrain model 216A to predict an expected reward as a function of the state of simulator 150. The training results in new values for the optimal action-value function (e.g., represented by Q table 116). Reinforcement learning module 211 updates a neural network (or Q table 116) based on these new values, thereby resulting in updated model 216B. Thereafter, when reinforcement learning module 211 directs agent module 212 to perform a simulation, agent module 212 uses the updated model 216B to select actions during the simulation.

The process of running simulations and collecting experience data 227 and assembling the experience data into a sorted list 328 for each episode 228 may continue, followed by retraining model 216 using the sorted lists 328. Note that in some cases, rather than assembling the experience data into a new sorted list 328, it may be more efficient for computing system 200 to re-sort an existing list 328 by the appropriate attribute, to the extent it changes after a simulation. In the example being described, lists 328 are sorted by error. However, in other examples, lists 328 be may sorted by any appropriate attribute, such another type of error or temporal difference error (“TD error”), reward received, sequence index, or other attribute.

For reinforcement learning problems that involve continuous scenarios that might not have a termination condition, computing system 200 may follow a similar process. For example, reinforcement learning module 211 may group experiences into trajectories, and then sample experiences from specific trajectories, choosing such trajectories uniformly, based on a probability distribution function, or in another manner. For a given batch size k, for example, reinforcement learning module 211 may select k experiences from one trajectory of experience data 227, perhaps selecting the experiences from that trajectory using a probability distribution function as described in connection with FIG. 2C and FIG. 2D.

In another example, again given batch size k, reinforcement learning module 211 may select k trajectories and only sample one instance of experience data 227 from each trajectory. Other sampling techniques could also be applied to continuous (or episodic) reinforcement learning problems.

As in FIG. 2A, the simulation and retraining process described in the context of FIG. 2B may be performed repeatedly. Over time, such repeated retraining may improve and/or refine the optimal action-value function (or model) used by agent module 212 to skillfully predict actions that will result in the highest future reward for a given state. As in FIG. 2A, agent module 212 becomes more skilled at landing object 151 on landing pad 152 without crashing.

FIG. 2C is a chart illustrating a sample frequency distribution for selecting experiences from a list of experiences that are sorted by an attribute of the experiences, in accordance with one or more aspects of the present disclosure. Chart 281 of FIG. 2C is intended to illustrate a power law distribution function as a function of a sample index ranging from 0 to 31. Chart 281 shows a sampling frequency for each of 32 experiences or records that might be stored in a sorted list 328. In FIG. 2C, the record at index 0 (e.g., corresponding to the experience with the highest error) is sampled at a high frequency rate (approximately 9% in the example shown), and as the list index increases to the end of the list at index 31, the rate at which records are sampled decreases to near zero. The effect of applying a sampling distribution during the process of selecting experiences for retraining is that the experiences with the largest attribute (e.g., largest error) will tend to be selected much more often than the experiences with low levels of the same attribute (e.g., low error). Applying this technique to lists of experiences sorted by error has been observed to be effective in training at least some types of models, resulting in models that are more accurate, are trained more quickly, and/or are trained with less computational resources.

FIG. 2D is a chart illustrating another sample frequency distribution for selecting experiences from a list of experiences that are sorted by an attribute of the experiences, in accordance with one or more aspects of the present disclosure. Chart 282 of FIG. 2D is intended to illustrate a gaussian distribution or, specifically, a truncated gaussian function or truncated half gaussian function. As in chart 281, chart 282 shows a sampling frequency for each of 32 experiences or records, with the record at index 0 (e.g., corresponding to the experience with the highest error) being sampled at a high frequency rate, and with the sampling frequency decreasing as the list index increases to the end of the list at index 31. As can be seen from a comparison of FIG. 2C and FIG. 2D, the sampling frequency in chart 282 decreases with the list index at a different rate than in chart 281. Applying a sampling distribution corresponding to that illustrated in FIG. 2D may also be effective in training at least some types of models, resulting in models that are more accurate, are trained more quickly, and/or are trained with less computational resources.

Other frequency distributions, beyond those illustrated in FIG. 2C and FIG. 2D, may also be appropriate for selecting experiences from a sorted list. Such other distributions may include triangular, normal, or linear frequency distributions.

FIG. 2E is a conceptual diagram illustrating an example of how performance of an agent may evolve during training across multiple epochs, in accordance with one or more aspects of the present disclosure. Performance graph 180 in FIG. 2E illustrates how the average reward obtained by agent module 212 evolves during training with simulator 150. To obtain average reward values, agent module 212 may be evaluated after each epoch by running tests to evaluate the skill of agent module 212. Specifically, the average reward obtained by agent module 212 during those tests is assessed for each epoch, and average reward values can be plotted as shown in performance graph 180.

In performance graph 180, each such data point is connected by a line. Accordingly, each line segment between data points in plot 181 of performance graph 180 shows a change in performance of agent module 212 after training with a given epoch 230 of training data. For example, segment 182A in performance graph 180 illustrates how performance of the agent improved after training with a particular epoch of data. After training with the next epoch of data, however, the performance of agent module 212 degraded, as shown by segment 182B. In general, performance graph 180 shows that while the skill of 212 seems to generally progress in the positive direction after most retraining operations, a high amount of variance is associated with that progress.

Notably, the variance illustrated in performance graph 180 suggests that some training epochs seem to be more effective at improving the skill of agent module 212 than others. Given these differences, reinforcement learning module 211 may be able to more effectively (or quickly) improve the skill of agent module 212 by selecting the right experience data 227 for training. One way to do so is for reinforcement learning module 211 to select experience data 227 by drawing from episodes 228 (or epochs 230) that tend to have certain desired attributes, or, as suggested in FIG. 2B, by drawing from experiences 227 that tend to have high error or some other specific attribute. For example, the retraining epochs that were used for segments 182A and 182C seem to include experiences and episode(s) that caused, after training, agent module 212 to thereafter perform well. This may have a number of causes, one of which may be that average reward value for the corresponding episodes was high. Given the improved performance, reinforcement learning module 211 may tend to select, for training purposes, experience data 227 that is drawn from episodes 228 associated with segments 182A and 182C (and their corresponding epochs 230) or specific experiences 227 from those episodes. In order to identify such experience data 227, reinforcement learning module 211 may use information about each experience (e.g., the amount of error associated with the experience 227) or may use episode data 229, which may include information about the average reward for a given episode 228 within each epoch 230.

Note that correspondingly, the training epoch underlying segment 182B seems to include episodes 228 where the average reward values were not as high, or that otherwise caused agent module 212 to thereafter perform poorly. Reinforcement learning module 211 may, in some examples, tend to avoid selecting (for training purposes) experience data 227 that is drawn from episodes associated with segment 182B. Again, reinforcement learning module 211 may use episode data 229 in order to identify such experience data 227.

Modules illustrated in FIG. 2A (e.g., reinforcement learning module 211, agent module 212) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

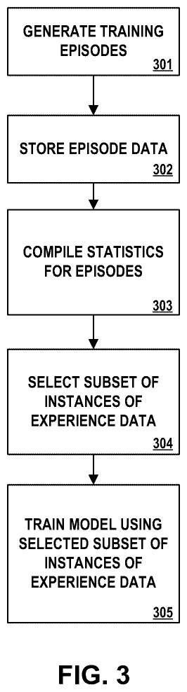

FIG. 3 is a flow diagram illustrating operations performed by an example computing system in accordance with one or more aspects of the present disclosure. FIG. 3 is described below within the context of computing system 200 of FIG. 2A. In other examples, operations described in FIG. 3 may be performed by one or more other components, modules, systems, or devices. Further, in other examples, operations described in connection with FIG. 3 may be merged, performed in a difference sequence, omitted, or may encompass additional operations not specifically illustrated or described.

In the process illustrated in FIG. 3, and in accordance with one or more aspects of the present disclosure, computing system 200 may generate episode data (301). For example, reinforcement learning module 211 of computing system 200 causes agent module 212 to interact with simulator 150 to initiate a simulation. Agent module 212 identifies a sequence of states, and for each state, applies one of models 216 to choose the action expected to result in the highest future reward associated with the environment of simulator 150. Agent module 212 performs each chosen action. For each action, agent module 212 observes the effect on simulator 150, and notes any reward received in response to the action and the next state of simulator 150. Agent 112 continues performing actions until a termination state is reached, marking the completion of an episode. Agent 112 may continue the process, thereby generating information about multiple episodes.

Computing system 200 may store episode data (302). For example, agent module 212 outputs information about the interactions with simulator 150 to reinforcement learning module 211. Reinforcement learning module 211 determines that agent module 212 has interacted with simulator 150 enough to complete one or more episodes. Reinforcement learning module 211 stores information about each of the episodes in data store 220 as episode data 228.

Computing system 200 may compile statistics associated with the episodes (303). For example, reinforcement learning module 211 evaluates episode data generated by agent module 212 and complies information about attributes of each episode 228. In some examples, such attributes may take the form of statistics about the rewards received during the episodes. Reinforcement learning module 211 stores information about the statistics as episode data 229.

Computing system 200 may select a subset of the instances of experience data (304). For example, reinforcement learning module 211 may, when seeking to train or retrain one of models 216, select training data from data store 220. Reinforcement learning module 211 selects instances of experience data 227 based on episode data 229, which may result in a tendency for reinforcement learning module 211 to select experience data 227 drawn from those episodes 228 having high reward values (as identified by episode data 229).

Computing system 200 may train a model 216 (305). For example, reinforcement learning module 211 trains or retrains one of models 216 using the selected experience data 227. As a result of the training, agent module 212 becomes more skilled at predicting an optimal action to take in a reinforcement learning model, wherein the optimal action is an action expected to result in a maximum future reward.

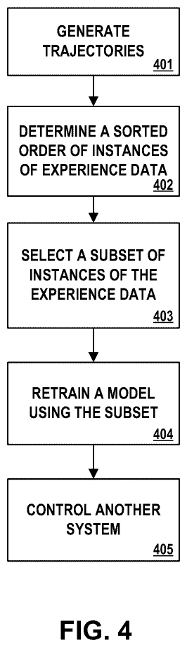

FIG. 4 is another flow diagram illustrating operations performed by an example computing system in accordance with one or more aspects of the present disclosure. FIG. 4 is described below within the context of computing system 200 of FIG. 2B. In other examples, operations described in FIG. 4 may be performed by one or more other components, modules, systems, or devices. Further, in other examples, operations described in connection with FIG. 4 may be merged, performed in a difference sequence, omitted, or may encompass additional operations not specifically illustrated or described.

In the process illustrated in FIG. 4, and in accordance with one or more aspects of the present disclosure, computing system 200 may generate trajectories (401). For example, reinforcement learning module 211 of computing system 200 causes agent module 212 to interact with simulator 150 to initiate a simulation. Agent module 212 starts interacting with simulator 150 and continues repeated interactions, sequencing through a number of states, and generating a corresponding sequence of contiguous experience data 227. In doing so, agent module 212 is creating a sequence of experience data 227 representing a trajectory, where the sequence may correspond to a portion of an episode or all of an episode. In some examples, such as in a continuous reinforcement learning problem, the sequence of experience data 227 representing the trajectory might not be episodic in the sense that it ends in a state having a termination condition. Agent module 212 may interact with simulator 150 to generate a plurality of trajectories.

When interacting with the simulator 150, agent module 212 applies model 216A to predict a reward for each possible action in a given state, and agent module 212 chooses an action based on the prediction. Agent module 212 performs each chosen action. For each action, agent module 212 observes the effect of the action on simulator 150, including any reward received in response to the action. Agent module 212 determines, based on the observed reward and the reward predicted by model 216A, an error value.

Computing system 200 may determine a sorted order of instances of experience data (402). For example, reinforcement learning module 211 sorts the experience data 227 for each trajectory by the determined error values. Reinforcement learning module 211 may place the experience data 227 for each trajectory into different sorted lists 328 for each trajectory, thereby facilitating selection of, for each trajectory, instances of experience data 227 that have high error.

Computing system may select a subset of the instances of experience data (403). For example, reinforcement learning module selects instances of experience data 227 from one of the sorted lists 328, such as list 328A, using a probability distribution function. In some examples, the distribution function causes reinforcement learning module 211 to select high error value instances of experience data 227 in list 328A more frequently than low error value instances of experience data 227 in list 328A.

Computing system 200 may retrain a model using the subset (404). For example, reinforcement learning module 211 retrains model 216A using the selected experience data 227. As a result of the training, model 216B is better able to accurately predict rewards resulting from actions in various states. By applying the retrained model 216B, agent module 212 becomes more skilled at predicting an optimal action to take in a reinforcement learning model, wherein the optimal action is an action expected to result in a maximum future reward.

Computing system 200 may send control signals to control another system (405). For example, reinforcement learning module 211 of computing system 200 causes agent module 212 to interact with a production system (not specifically shown in FIG. 2B). In some examples, the production system is a system which simulator 150 is intended to simulate, such as a robotic control system that controls the operation of a physical vehicle or other physical object. In other examples, the production system may be a lunar lander control system or video game that is the same as or similar to the simulator 150. Other types of production systems are possible. When preparing to send control signals, agent module 212 identifies a sequence of states, and for each state, applies the retrained model (e.g., model 216B) to choose an action. The agent module 212 sends control signals to the production system, possibly at each state, instructing the production system to perform the chosen action. The actions chosen by the agent module 212 manipulate or control the production system, and typically exhibit skill in doing so. Accordingly, computing system 200 controls the production system to achieve a desired result (e.g., effectively maneuver the robotic control system or skillfully play a video game).

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any such disclosure material that is incorporated by reference conflicts with the present disclosure, the present disclosure shall control.

For ease of illustration, a limited number of devices or systems (e.g., simulator 150, agent 112, computing system 200, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A computing system comprising a storage device and processing circuitry having access to the storage device, wherein the processing circuitry is configured to:
generate a plurality of trajectories, each comprising a contiguous sequence of instances of experience data, where each instance of experience data in the contiguous sequence has an error value associated with that instance of experience data;
determine, for each of the trajectories, a sorted order of the instances of experience data, wherein the sorted order is based on the error value associated with each of the instances of experience data;
select, based on a distribution function applied to the sorted order of the instances of experience data in at least one of the trajectories, a subset of instances of the experience data; and
retrain a reinforcement learning model, using the subset of instances of experience data, to predict an optimal action to take in a state.

2. The computing system of claim 1, wherein the plurality of trajectories includes a first trajectory and a second trajectory, and wherein to select the subset of instances, the processing circuitry is further configured to:
select a first subset of instances of the experience data from the first trajectory by applying a first distribution function to the sorted order of the instances of experience data in that first trajectory; and
select a second subset of instances of the experience data from the second trajectory by applying a second distribution function to the sorted order of the instances of experience data in that second trajectory.

3. The computing system of claim 2,
wherein the first distribution function is the same as the second distribution function.

4. The computing system of claim 1, wherein each of the plurality of trajectories correspond to a different one of a plurality of episodes, each episode ending with an instance of experience data having a termination condition, and wherein to generate the plurality of trajectories, the processing circuitry is further configured to:
generate the plurality of episodes.

5. The computing system of claim 4, wherein to determine the sorted order, the processing circuitry is further configured to:
determine, for each of the episodes, the sorted order of the instances of experience data.

6. The computing system of claim 1, wherein to select the subset of instances, the processing circuitry is further configured to:
select, at a first frequency rate, instances of the experience data having high error; and
select, at a second frequency rate, instances of the experience data having less than high error, wherein the first frequency rate is greater than the second frequency rate.

7. The computing system of claim 6, wherein to select the subset of instances, the processing circuitry is further configured to:
apply at least one of a power law distribution function or a truncated half gaussian distribution to the sorted order of the instances of experience data.

8. The computing system of claim 1,
wherein the error value associated with each of the instances of experience data is a temporal difference error.

9. The computing system of claim 1,
wherein the error value associated with each of the instances of experience data is a difference between an observed reward received during a simulation and an expected reward based on a prediction made by the reinforcement learning model.

10. The computing system of claim 1, wherein the processing circuitry is further configured to:
send control signals to a production system once the reinforcement learning model is retrained, the control signals instructing the production system to take actions specified in the control signals and wherein the control signals are based on outputs generated by the retrained reinforcement learning model.

11. A method comprising:
generating, by a computing system, a plurality of trajectories, each comprising a contiguous sequence of instances of experience data, where each instance of experience data in the contiguous sequence has an error value associated with that instance of experience data;
determining, by the computing system and for each of the trajectories, a sorted order of the instances of experience data, wherein the sorted order is based on the error value associated with each of the instances of experience data;
selecting, by the computing system and based on a distribution function applied to the sorted order of the instances of experience data in at least one of the trajectories, a subset of instances of the experience data; and
retraining, by the computing system, a reinforcement learning model, using the subset of instances of experience data, to predict an optimal action to take in a state.

12. The method of claim 11, wherein the plurality of trajectories includes a first trajectory and a second trajectory, and wherein selecting the subset of instances includes:
selecting a first subset of instances of the experience data from the first trajectory by applying a first distribution function to the sorted order of the instances of experience data in that first trajectory; and
selecting a second subset of instances of the experience data from the second trajectory by applying a second distribution function to the sorted order of the instances of experience data in that second trajectory.

13. The method of claim 12,
wherein the first distribution function is the same as the second distribution function.

14. The method of claim 11, wherein each of the plurality of trajectories correspond to a different one of a plurality of episodes, each episode ending with an instance of experience data having a termination condition, and wherein generating the plurality of trajectories includes:
generating the plurality of episodes.

15. The method of claim 14, wherein determining the sorted order includes:
determining, for each of the episodes, the sorted order of the instances of experience data.

16. The method of claim 11, wherein selecting the subset of instances includes:
selecting, at a first frequency rate, instances of the experience data having high error; and
selecting, at a second frequency rate, instances of the experience data having less than high error, wherein the first frequency rate is greater than the second frequency rate.

17. The method of claim 16, wherein selecting the subset of instances includes:
applying a power law distribution function to the sorted order of the instances of experience data.

18. The method of claim 16, wherein selecting the subset of instances includes:
applying a truncated half gaussian distribution to the sorted order of the instances of experience data.

19. The method of claim 11,
wherein the error value associated with each of the instances of experience data is a temporal difference error.

20. A non-transitory computer-readable medium comprising instructions that, when executed, cause processing circuitry of a computing system to:
generate a plurality of trajectories, each comprising a contiguous sequence of instances of experience data, where each instance of experience data in the contiguous sequence has an error value associated with that instance of experience data;
determine, for each of the trajectories, a sorted order of the instances of experience data, wherein the sorted order is based on the error value associated with each of the instances of experience data;
select, based on a distribution function applied to the sorted order of the instances of experience data in at least one of the trajectories, a subset of instances of the experience data; and
retrain a reinforcement learning model, using the subset of instances of experience data, to predict an optimal action to take in a state.
